(19) United States
(12) Patent Application Publication
(10) Pub. No.: US 2015/0369275 A1
(43) Pub. Date: Dec. 24, 2015

(54) BOLT AND NUT COMBINATION HAVING A POSITIONING DEVICE

(71) Applicant: KABO TOOL COMPANY, Taichung City (TW)

(72) Inventor: Chih-Ching HSIEH, Taichung City (TW)

(21) Appl. No.: 14/723,915

(22) Filed: May 28, 2015

(30) Foreign Application Priority Data
Jun. 18, 2014 (TW) 103121060

(51) Int. Cl. F16B 39/06

(52) U.S. Cl. CPC F16B 39/06

(57) ABSTRACT

A bolt and nut combination includes a bolt including a shank formed with a bolt head and having a threaded portion; at least one groove formed longitudinally on the threaded portion, each groove being at a first angle with respect to an axis of the threaded portion and the first angle being not equal to 90-degree; a nut including a threaded hole configured to secure to the threaded portion; at least one trough formed longitudinally on the threaded hole, each trough being at a second angle with respect to an axis of the threaded portion and the second angle being not equal to 90-degree; and at least one elongated, resilient positioning device, each positioning device including a main portion and a positioning portion. In one embodiment, the main portion is disposes in the trough and the positioning portion is disposed in the groove.

### BACKGROUND OF THE INVENTION

1. Field of the Invention

The invention relates to threaded fasteners and more particularly to a bolt and nut combination having a positioning device disposed in between the bolt and the nut so that clamped components can be fastened by the bolt and nut combination without being loosened.

2. Description of Related Art

Bolt and nut combinations are typically used to fasten clamped components. However, clamped components fastened by the fastening of the bolt 20 and the nut 30 may be loosened in a highly vibrating environment, a high temperature environment or the like.

A conventional bolt 74 and nut 72 combination is shown in FIG. 14. Two opposite, resilient urging devices 70 are disposed in between the nut 72 and the threaded portion of the bolt 74. The urging devices 70 urge against both the threaded portion of the bolt 74 and the nut 72 to increase the fastening. However, it is highly possible that the bolt 20 and the nut 30 may be loosened in a highly vibrating environment, a high temperature. Thus, the need for improvement still exists.

### SUMMARY OF THE INVENTION

It is therefore one object of the invention to provide a bolt and nut combination comprising a bolt including a bolt head and a shank formed with the bolt head and having a threaded portion; at least one groove formed longitudinally on a surface of the threaded portion, each of the at least one groove being at a first angle with respect to an axis of the threaded portion and the first angle being not equal to 90-degree; a nut including a threaded hole configured to secure to the threaded portion; at least one trough formed longitudinally on the threaded hole, each of the at least one trough being at a second angle with respect to an axis of the threaded portion and the second angle being not equal to 90-degree; and at least one positioning device each being elongated, resilient, each of the at least one positioning device including a main portion and a positioning portion; wherein the main and positioning portions are configured to resiliently draw near each other or resiliently draw away each other; and wherein the main portion is configured to dispose in the trough and the positioning portion is configured to dispose in the groove, or the main portion is configured to dispose in the groove and the positioning portion is configured to dispose in the trough.

The above and other objects, features and advantages of the invention will become apparent from the following detailed description taken with the accompanying drawings.

### BRIEF DESCRIPTION OF THE DRAWINGS

FIG. 1 is a perspective view of a bolt and nut combination having a positioning device according to a first preferred embodiment of the invention;

FIG. 2 is an exploded view of FIG. 1 with the positioning device removed;

FIG. 3 is a perspective view of the positioning device;

FIG. 4 is a longitudinal sectional view of the bolt with the positioning device disposed in the groove and hole;

FIG. 5 is a longitudinal sectional view of the bolt and nut combination having the positioning device disposed in between the bolt and the nut for fastening two clamped components together;

FIG. 6 is a sectional view taken along line 6-6 of FIG. 5;

FIG. 7 is a perspective view of a bolt and nut combination according to a second preferred embodiment of the invention, a positioning being disposed in the trough of the nut which is separated from the bolt;

FIG. 8 is a longitudinal sectional view of the nut of FIG. 7 showing the positioning device disposed in the trough of the nut;

FIG. 9 is a longitudinal sectional view of the bolt and nut combination of FIG. 7 having the positioning device disposed in between the bolt and the nut for fastening two clamped components together;

FIG. 10 is a sectional view taken along line 10-10 of FIG. 9;

FIG. 11 is a perspective view of a bolt and nut combination according to a third preferred embodiment of the invention, a first positioning being disposed in one of the grooves of the bolt and a second positioning being disposed in one of the troughs of the nut which is separated from the bolt;

FIG. 12 is a longitudinal sectional view of the bolt and nut combination of FIG. 11 having the first and second positioning devices disposed in between the bolt and the nut for fastening two clamped components together;

FIG. 13 is a sectional view taken along line 13-13 of FIG. 12; and

FIG. 14 is a side elevation in part section of a conventional bolt and nut combination having two urging devices disposed in between the threaded portion of the bolt and the nut.

### DETAILED DESCRIPTION OF THE INVENTION

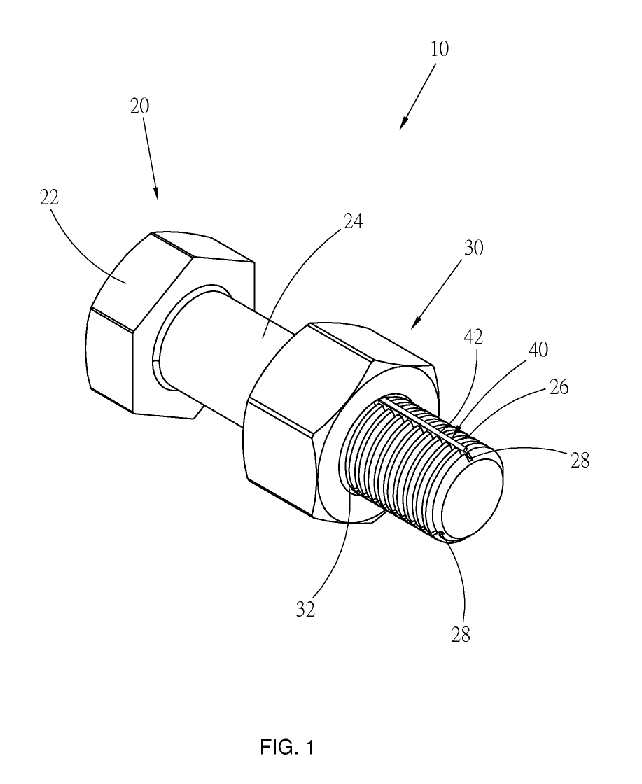

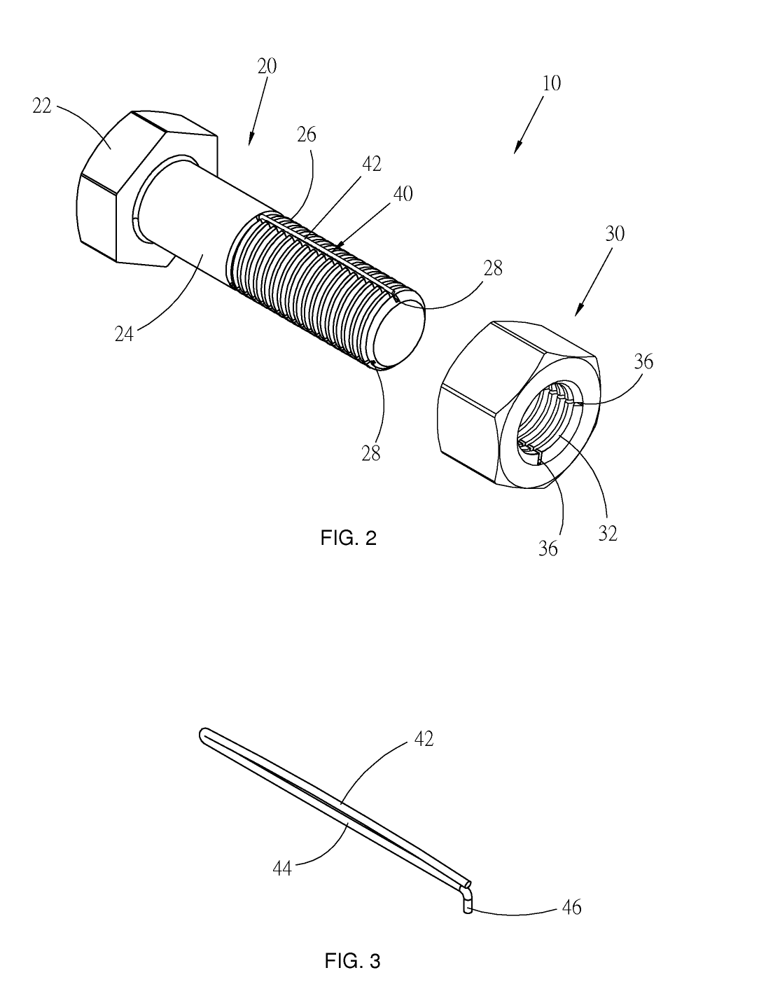

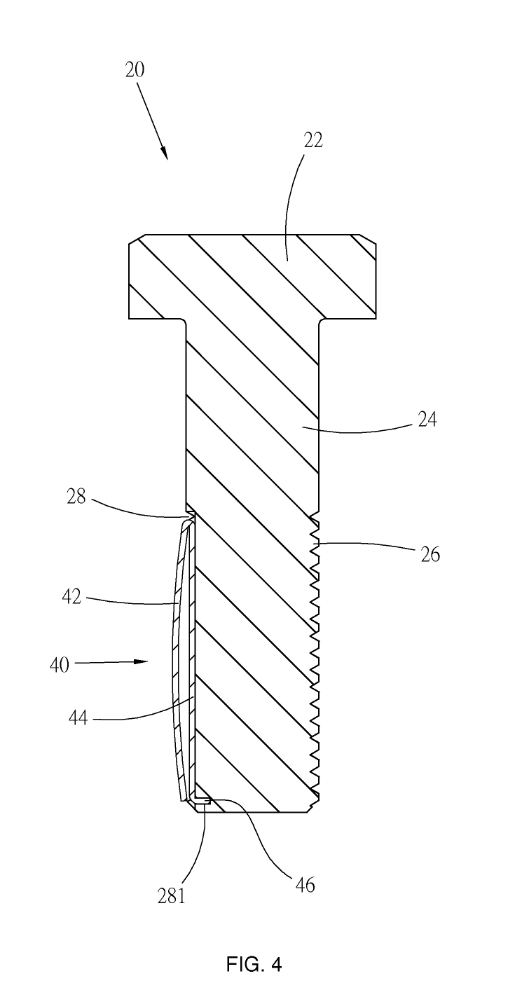

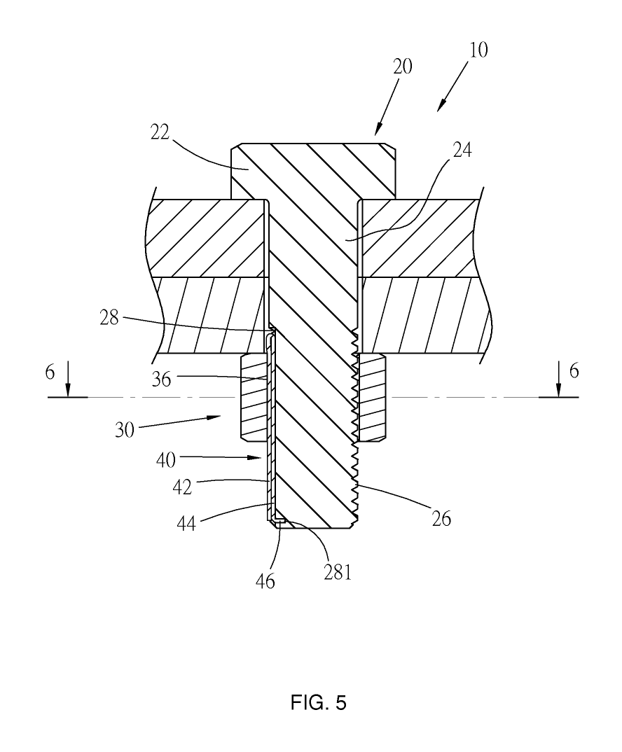

Referring to FIGS. 1 to 6, a bolt and nut combination having a positioning device 10 in accordance with a first preferred embodiment of the invention comprises the following components as discussed in detail below.

A bolt 20 includes a bolt head 22 and a shank 24 formed with the bolt head 22 and having a threaded portion 26. Two spaced grooves 28 are formed longitudinally on a surface of the threaded portion 26. Each groove 28 has a short hole 281 proximate an end of the threaded portion 26. The hole 281 communicates with the groove 28 and they are perpendicular to each other.

A nut 30 includes a threaded hole 32 configured to secure to the threaded portion 26. Three equally spaced troughs 36 are formed longitudinally on the threaded hole 32. A positioning device 40 is an elongated, resilient metal and has a length equal to or less than the length of the threaded portion 26. The positioning device 40 includes a main portion 44, a curved positioning portion 42 formed by bending the main portion 44, the positioning portion 42 having a length substantially equal to that of the main portion 44, and a short insert portion 46 formed at an end of the main portion 44 and being perpendicular thereto.

The insert portion 46 is inserted into the hole 281, the main portion 44 is disposed in the groove 28, and the positioning portion 42 is disposed in the trough 36 when the bolt 20 and the nut 30 are secured together by rotating the nut 30 along the threaded portion 26. It is envisaged by the invention that the positioning portion 42 urges against the trough 36 and thus the clamped components fastened by the fastening of the bolt 20 and the nut 30 are more secure without being loosened in a highly vibrating environment, a high temperature environment or the like.

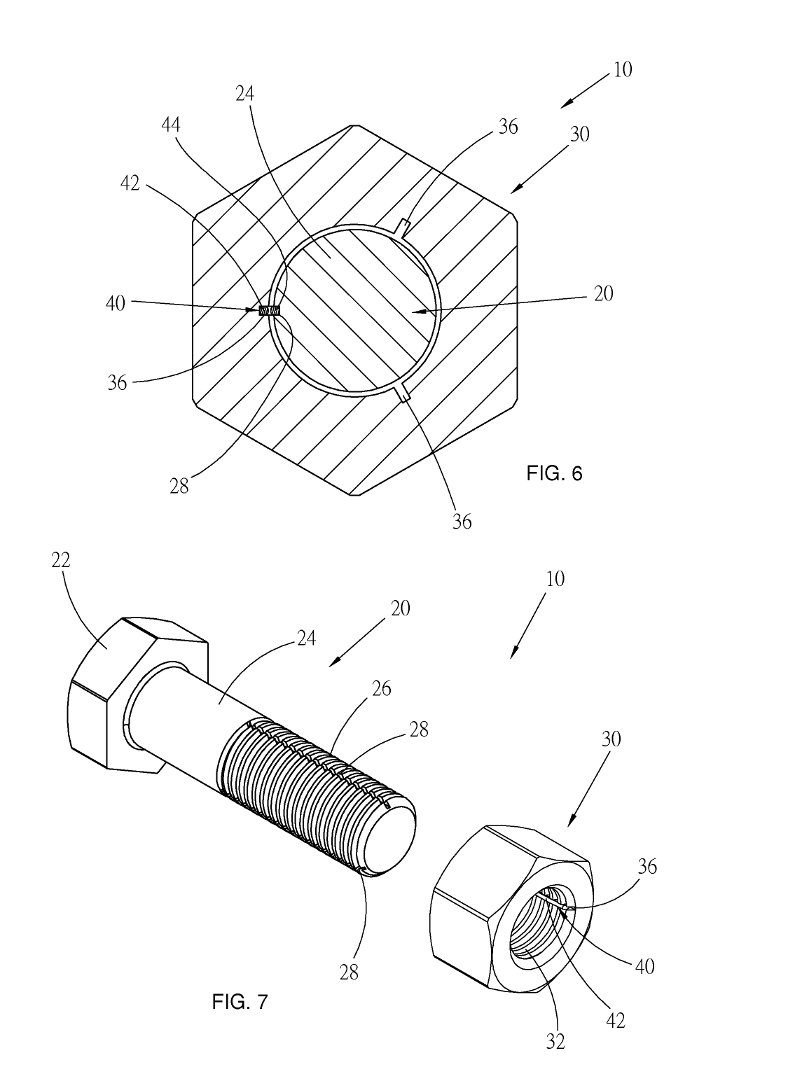

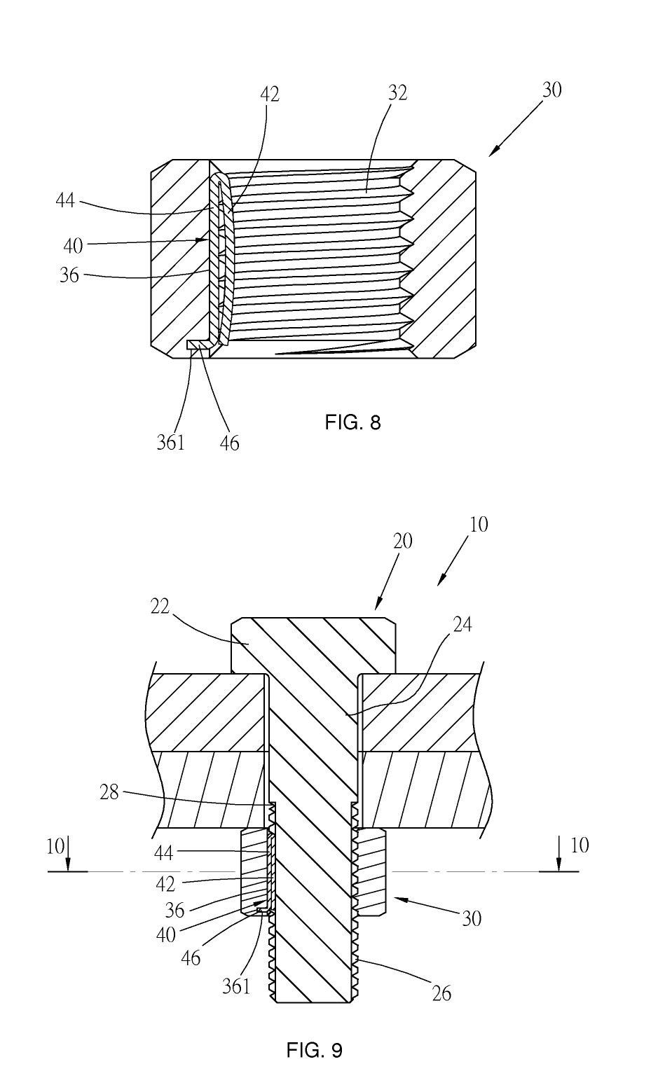

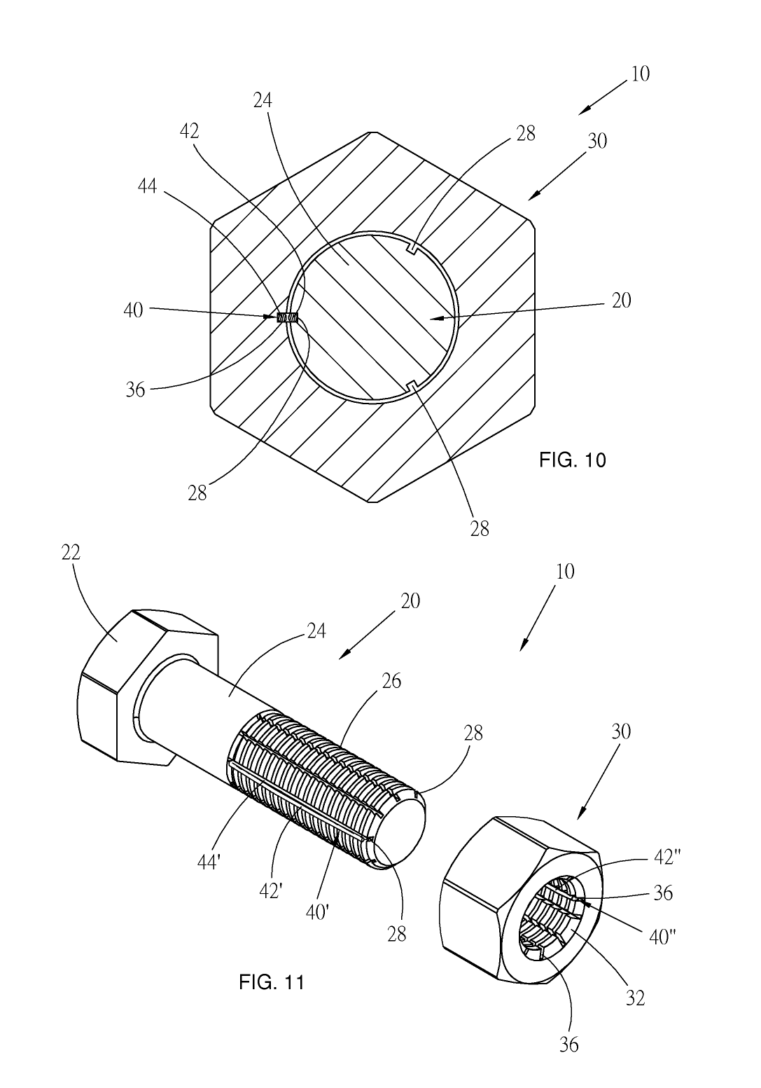

Referring to FIGS. 7 to 10, a bolt and nut combination having a positioning device 10 in accordance with a second preferred embodiment of the invention is shown. The characteristics of the second preferred embodiment are substantially the same as that of the first preferred embodiment except the following:

A nut 30 includes a threaded hole 32 configured to secure to the threaded portion 26. A trough 36 is formed longitudinally on the threaded hole 32. The trough 36 has a short hole 361 proximate an end of the nut 30 distal the bolt head 22. The hole 361 communicates with the trough 36 and they are perpendicular to each other. A positioning device 40 is an elongated, resilient metal and has a length equal to or less than the length of the threaded hole 32. The positioning device 40 includes a main portion 44, a curved positioning portion 42 formed by bending the main portion 44, the positioning portion 42 having a length substantially equal to that of the main portion 44, and a short insert portion 46 formed at an end of the main portion 44 and being perpendicular thereto.

The insert portion 46 is inserted into the hole 361 and the main portion 44 is disposed in the trough 36. The bolt 20 and the nut 30 are secured together by rotating the nut 30 along the threaded portion 26. It is envisaged by the invention that the positioning portion 42 urges against the threaded portion 26 and thus the clamped components fastened by the fastening of the bolt 20 and the nut 30 are more secure without being loosened in a highly vibrating environment, a high temperature environment or the like.

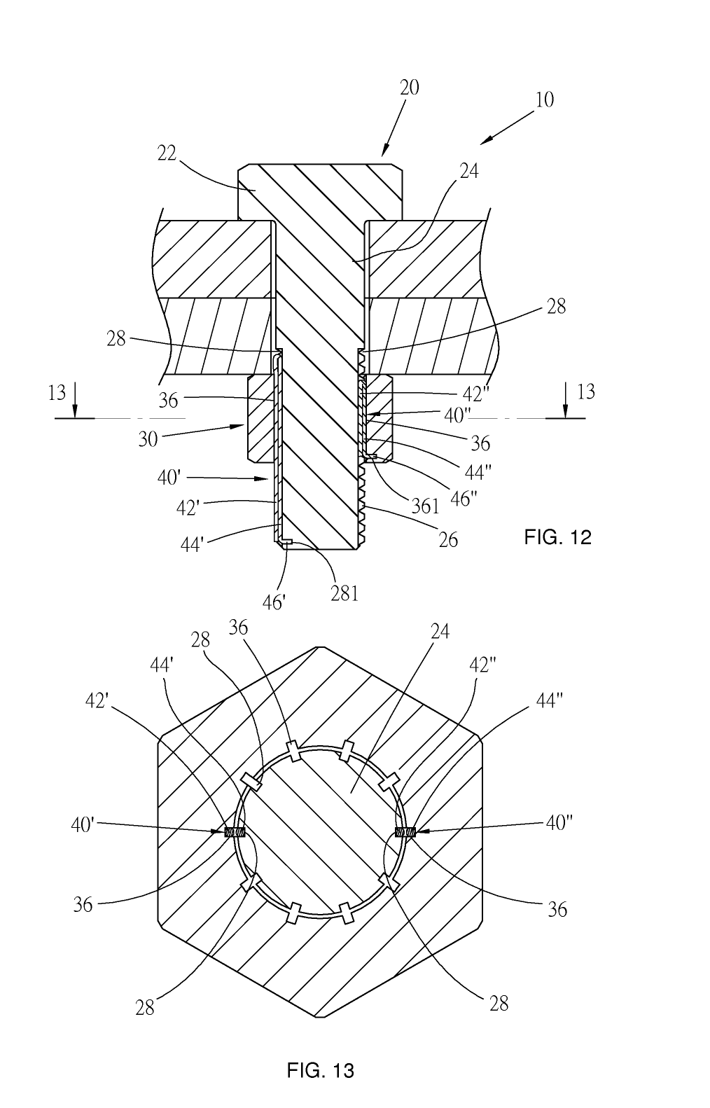

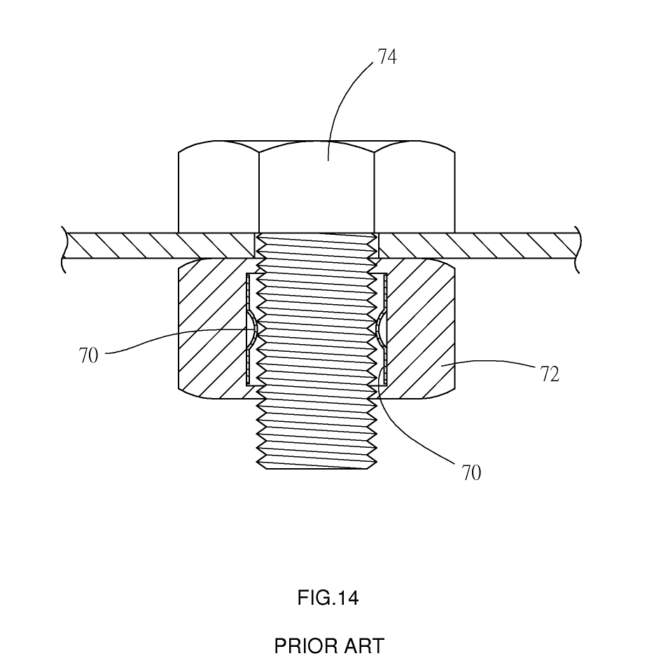

Referring to FIGS. 11 to 13, a bolt and nut combination having a positioning device 10 in accordance with a third preferred embodiment of the invention is shown. The characteristics of the third preferred embodiment are substantially the same as that of a combination of the first and second preferred embodiments as detailed below.

A bolt 20 includes a bolt head 22 and a shank 24 formed with the bolt head 22 and having a threaded portion 26. A plurality of equally spaced grooves 28 are formed longitudinally on a surface of the threaded portion 26. Each groove 28 has a short hole 281 proximate an end of the threaded portion 26. The hole 281 communicates with the groove 28 and they are perpendicular to each other. A first positioning device 40′ is an elongated, resilient metal and has a length equal to or less than the length of the threaded portion 26. The first positioning device 40′ includes a main portion 44′, a curved positioning portion 42′ formed by bending the main portion 44′, the positioning portion 42′ having a length substantially equal to that of the main portion 44, and a short insert portion 46′ formed at an end of the main portion 44′ and being perpendicular thereto.

A nut 30 includes a threaded hole 32 configured to secure to the threaded portion 26. A plurality of equally spaced roughs 36 are formed longitudinally on the threaded hole 32. The trough 36 has a short hole 361 proximate an end of the nut 30 distal the bolt head 22. The hole 361 communicates with the trough 36 and they are perpendicular to each other. A second positioning device 40″ is an elongated, resilient metal and has a length equal to or less than the length of the threaded hole 32. The second positioning device 40″ includes a main portion 44″, a curved positioning portion 42″ formed by bending the main portion 44″, the positioning portion 42″ having a length substantially equal to that of the main portion 44″, and a short insert portion 46″ formed at an end of the main portion 44″ and being perpendicular thereto.

The insert portion 46″ is inserted into the hole 361 and the main portion 44″ is disposed in the trough 36. The bolt 20 and the nut 30 are secured together by rotating the nut 30 along the threaded portion 26. It is envisaged by the invention that the positioning portion 42′ of the first positioning device 40′ urges against the threaded hole 32 and the positioning portion 42″ of the second positioning device 40″ urges against the threaded portion 26. Thus, the clamped components fastened by the fastening of the bolt 20 and the nut 30 are more secure without being loosened in a highly vibrating environment, a high temperature environment or the like.

While the invention has been described in terms of preferred embodiments, those skilled in the art will recognize that the invention can be practiced with modifications within the spirit and scope of the appended claims.

What is claimed is:

1. A bolt and nut combination comprising:
a bolt including a bolt head and a shank formed with the bolt head and having a threaded portion;
at least one groove formed longitudinally on a surface of the threaded portion, each of the at least one groove being at a first angle with respect to an axis of the threaded portion and the first angle being not equal to 90-degree;
a nut including a threaded hole configured to secure to the threaded portion;
at least one trough formed longitudinally on the threaded hole, each of the at least one trough being at a second angle with respect to an axis of the threaded portion and the second angle being not equal to 90-degree; and
at least one positioning device each being elongated, resilient, each of the at least one positioning device including a main portion and a positioning portion;
wherein the main and positioning portions are configured to resiliently draw near each other or resiliently draw away each other; and
wherein the main portion is configured to dispose in the trough and the positioning portion is configured to dispose in the groove, or the main portion is configured to dispose in the groove and the positioning portion is configured to dispose in the trough.

2. The bolt and nut combination of claim 1, wherein at least one trough is formed longitudinally on the threaded hole; wherein at least one groove is formed longitudinally on the surface of the threaded portion; and wherein the main portion is configured to dispose in the groove and the positioning portion is configured to dispose in the trough.

3. The bolt and nut combination of claim 1, wherein at least one trough is formed longitudinally on the threaded hole; wherein at least one groove is formed longitudinally on the surface of the threaded portion; and wherein the main portion is configured to dispose in the trough and the positioning portion is configured to dispose in the groove.

4. The bolt and nut combination of claim 1, wherein a plurality of equally spaced grooves formed longitudinally on the surface of the threaded portion; and a plurality of troughs formed longitudinally on the threaded hole; wherein the number of the at least one positioning device is at least two; wherein the main portion of one positioning device is disposed in the groove of the bolt, and the positioning portion of one positioning device is disposed in the trough of the nut; and wherein the main portion of the other positioning device is disposed in the trough of the nut, and the positioning portion of the other positioning device is disposed in the groove of the bolt.

5. The bolt and nut combination of claim 1, wherein the main portion of the positioning device includes an insert portion formed at an end; wherein the groove includes a hole proximate an end of the threaded portion; and wherein the insert portion is inserted into the hole.

6. The bolt and nut combination of claim 2, wherein the main portion of the positioning device includes an insert portion formed at an end; wherein the groove includes a hole proximate an end of the threaded portion; and wherein the insert portion is inserted into the hole.

7. The bolt and nut combination of claim 4, wherein the main portion of the positioning device includes an insert portion formed at an end; wherein the groove includes a hole proximate an end of the threaded portion; and wherein the insert portion is inserted into the hole.

8. The bolt and nut combination of claim 1, wherein the main portion of the positioning device includes an insert portion formed at an end; wherein the trough includes a hole proximate one end of the nut; and wherein the insert portion is inserted into the hole.

9. The bolt and nut combination of claim 3, wherein the main portion of the positioning device includes an insert portion formed at an end; wherein the trough includes a hole proximate one end of the nut; and wherein the insert portion is inserted into the hole.

10. The bolt and nut combination of claim 4, wherein the main portion of the positioning device includes an insert portion formed at an end; wherein the trough includes a hole proximate one end of the nut; and wherein the insert portion is inserted into the hole.

11. The bolt and nut combination of claim 1, wherein the main portion is parallel to the positioning portion; and wherein one end of the main portion is joined one end of the positioning portion.

12. The bolt and nut combination of claim 1, wherein the groove is parallel to an axis of the threaded portion of the bolt; and wherein the trough is parallel to an axis of the threaded hole of the nut.

13. The bolt and nut combination of claim 1, wherein the positioning device is made of resilient metal.
